(19) United States
(12) Patent Application Publication
(10) Pub. No.: US 2014/0082080 A1
(43) Pub. Date: Mar. 20, 2014

(54) ONLINE SOCIAL NETWORKING INTERACTION METHOD AND RELATED DEVICE AND SYSTEM

(71) Applicant: Tencent Technology (Shenzhen) Company Limited, Shenzhen (CN)

(72) Inventors: Cheng Gong NING, Shenzhen (CN); Xue Ke HUANG, Shenzhen (CN); Ming Hui WANG, Shenzhen (CN); Ming Zhong JI, Shenzhen (CN); Xiao Jun HUANG, Shenzhen (CN); Zhu LIANG, Shenzhen (CN); Zhi Hao ZHENG, Shenzhen (CN); Hui Xing WANG, Shenzhen (CN); Hua Bin XU, Shenzhen (CN); Guang Hai WEN, Shenzhen (CN); Zhi Hua WU, Shenzhen (CN)

(73) Assignee: Tencent Technology (Shenzhen) Company Limited, Shenzhen (CN)

(21) Appl. No.: 14/069,121

(22) Filed: Oct. 31, 2013

Related U.S. Application Data
(63) Continuation of application No. PCT/CN2013/083661, filed on Sep. 17, 2013.

(30) Foreign Application Priority Data
Sep. 20, 2012 (CN) 201210350653.3

(51) Int. Cl. H04L 29/08

(52) U.S. Cl. CPC H04L 67/22
USPC 709/204

(57) ABSTRACT

An online social networking interaction method and related device and system comprise: an initiation terminal sending a command carrying an event location and a target terminal identification entered by a user on a social networking platform to a service device; the service device sending a message carrying the event location to a target terminal based on the target terminal identification after receiving the command; the target terminal detecting whether the target terminal is present at the event location after receiving the message carrying the event location, and sending a notification that the target terminal is present at the event location to the service device if the target terminal is present; the service device sending the notification that the target terminal is present at the event location to the initiation terminal; and the target terminal detecting whether the target terminal is not present at the event location, and prompting the user to perform one or more social networking interaction operations if the target terminal is not present. The present disclosure can remind users to perform social networking interaction operations after social networking events, so that information about the social networking events can be shared with friends.

### CROSS REFERENCE TO RELATED APPLICATION

This application is a U.S. continuation application under 35 U.S.C. §111(a) claiming priority under 35 U.S.C. §§120 and 365(c) to International Application No. PCT/CN2013/083661 filed on Sep. 17, 2013, which claims the priority benefit of Chinese Patent Application No. 201210350653.3, filed Sep. 20, 2012, the contents of both the PCT application and the Chinese application are incorporated by reference herein in their entirety for all purposes.

### TECHNICAL FIELD

The present disclosure relates generally to the technological field of social network sites, particularly to an online social networking interaction method and related device and system.

### BACKGROUND

On social network sites, users often receive event invitations from their friends via certain social networking platforms (e.g., personal spaces or microblogs), and participate in social networking events such as meetings, chatting, and shopping at designated event locations. In addition, after a social networking event, users can not only publish videos and pictures they took during the social networking event on social networking platforms to promptly share them with friends, but also publish their feelings about the social networking event on social networking platforms in the form of weblogs, etc. All of these activities can be called social networking interaction operations.

Current social networking service (“SNS”) systems lack a reminder mechanism. After a social networking event, there is no timely reminder information to remind users to promptly perform the above-mentioned social networking interaction operations. As a result, information about the social networking event (e.g., videos, pictures, and weblogs, etc.) cannot be promptly shared with friends.

### SUMMARY OF THE DISCLOSURE

One of the technical problems to be solved by embodiments of the present disclosure is to provide an online social networking interaction method and related device and system, which allow users to be reminded to perform social networking interaction operations after social networking events, so that information about the social networking events can be shared with friends.

A first aspect of the present disclosure provides an online social networking interaction method. The method can comprise:

an initiation terminal sending a command carrying an event location and a target terminal identification entered by a user on a social networking platform to a service device;

the service device sending a message carrying the event location to a target terminal based on the target terminal identification after receiving the command;

the target terminal detecting whether the target terminal is present at the event location after receiving the message, and sending a notification that the target terminal is present at the event location to the service device if the target terminal is present;

the service device sending the notification that the target terminal is present at the event location to the initiation terminal; and

the target terminal detecting whether the target terminal is not present at the event location after sending the notification that the target terminal is present at the event location to the service device, and prompting the user to perform one or more social networking interaction operations if the target terminal is not present.

A second aspect of the present disclosure provides an online social networking interaction method. The method can comprise:

a target terminal receiving a message carrying an event location from a service device, wherein the message is sent from the service device based on a target terminal identification after the service device receives a command carrying the event location and the target terminal identification entered by a user on a social networking platform from an initiation terminal;

the target terminal detecting whether the target terminal is present at the event location, and sending a notification that the target terminal is present at the event location to the initiation terminal via the service device if the target terminal is present; and

the target terminal detecting whether the target terminal is not present at the event location after sending the notification that the target terminal is present at the event location to the initiation terminal via the service device, and prompting the user to perform one or more social networking interaction operations if the target terminal is not present.

A third aspect of the present disclosure provides an online social networking interaction method. The method can comprise:

an initiation terminal sending a command carrying an event location and a target terminal identification entered by a user on a social networking platform to a service device;

the service device sending a message carrying the event location to a target terminal based on the target terminal identification after receiving the command;

the target terminal detecting whether the target terminal is present at the event location after receiving the message, and sending a notification that the target terminal is present at the event location to the service device if the target terminal is present;

the service device sending the notification that the target terminal is present at the event location to the initiation terminal;

the target terminal sending the target terminal's location and the event location to the service device after sending the notification that the target terminal is present at the event location to the service device;

the service device comparing the target terminal's location and the event location to see whether they correspond after receiving the target terminal's location and the event location, and sending a command to perform one or more social networking interaction operations to the target terminal if the target terminal's location and the event location do not correspond; and

the target terminal prompting the user to perform the one or more social networking interaction operations after receiving the command to perform the one or more social networking interaction operations.

A fourth aspect of the present disclosure provides an online social networking interaction method. The method can comprise:

a service device receiving a command carrying an event location and a target terminal identification entered by a user on a social networking platform from an initiation terminal;

the service device sending a message carrying the event location to the target terminal based on the target terminal identification, enabling the target terminal to detect whether the target terminal is present at the event location after receiving the message, and to send a notification that the target terminal is present at the event location to the service device when the target terminal is present at the event location;

the service device receiving the target terminal's location and the event location from the target terminal after receiving the notification that the target terminal is present at the event location from the target terminal;

the service device comparing the target terminal's location and the event location to see if they correspond, and sending a command to perform one or more social networking interaction operations to the target terminal if the target terminal's location and the event location do not correspond, enabling the target terminal to prompt the user to perform the one or more social networking interaction operations after receiving the command to perform the one or more social networking interaction operations.

A fifth aspect of the present disclosure provides an online social networking interaction system comprising: an initiation terminal, a service device, and a target terminal, wherein

the initiation terminal sends a command carrying an event location and a target terminal identification entered by a user on a social networking platform to the service device,

the service device sends a message carrying the event location to the target terminal based on the target terminal identification after receiving the command,

the target terminal detects whether the target terminal is present at the event location after receiving the message, and sends a notification that the target terminal is present at the event location to the service device if the target terminal is present at the event location,

the service device sends the notification that the target terminal is present at the event location to the initiation terminal, and

the target terminal detects whether the target terminal is not present at the event location after sending the notification that the target terminal is present at the event location to the service device, and prompts the user to perform one or more social networking interaction operations if the target terminal is not present at the event location.

A sixth aspect of the present disclosure provides a target system comprising:

a receiving unit that receives a message carrying an event location from a service device, wherein the message is sent from the service device based on a target terminal identification after the service device receives a command carrying the event location and the target terminal identification entered by a user on a social networking platform from an initiation terminal,

a first detecting unit that detects whether the target terminal is present at the event location,

a sending unit that sends a notification that the target terminal is present at the event location to the initiation terminal via the service device when the first detecting unit detects that the target terminal is present at the event location,

a second detecting unit that detects whether the target terminal is not present at the event location after the sending unit sends the notification that the target terminal is present at the event location to the initiation terminal via the service device, and

a prompting terminal that prompts the user to perform one or more social networking interaction operations when the second detecting unit detects that the target terminal is not present at the event location.

A seventh aspect of the present disclosure provides an online social networking interaction system comprising: an initiation terminal, a service device, and a target terminal, wherein

the initiation terminal sends a command carrying an event location and a target terminal identification entered by a user on a social networking platform to the service device,

the service device sends a message carrying the event location to the target terminal based on the target terminal identification after receiving the command,

the target terminal detects whether the target terminal is present at the event location after receiving the message, and sends a notification that the target terminal is present at the event location to the service device if the target terminal is present at the event location,

the service device sends the notification that the target terminal is present at the event location to the initiation terminal,

the target terminal sends the target terminal's location and the event location to the service device after sending the notification that the target terminal is present at the event location to the service device,

the service device compares the target terminal's location and the event location after receiving the target terminal's location and the event location to see if they correspond, and sends a command to perform one or more social networking interaction operations to the target terminal if the target terminal's location and the event location do not correspond, and

the target terminal prompts the user to perform the one or more social networking interaction operations after receiving the command to perform the one or more social networking interaction operations.

An eighth aspect of the present disclosure provides a service device comprising:

a receiving unit that receives a command carrying an event location and a target terminal identification entered by a user on a social networking platform from an initiation terminal,

a sending unit that sends a message carrying the event location to a target terminal based on the target terminal identification, enabling the target terminal to detect whether the target terminal is present at the event location after receiving the message, and to send a notification that the target terminal is present at the event location to the service device when the target terminal is present at the event location, wherein

the receiving unit receives the notification that the target terminal is present at the event location from the target terminal,

the sending unit sends the notification that the target terminal is present at the event location to the initiation terminal, and

the receiving unit receives the target terminal's location and the event location after receiving the notification that the target terminal is present at the event location from the target terminal, and

a comparing unit that compares the target terminal's location and the event location to see whether they correspond, wherein

the sending unit sends a command to perform one or more social networking interaction operations to the target terminal when the comparing unit determines that the target terminal's location and the event location do not correspond, enabling the target terminal to prompt the user to perform the one or more social networking interaction operations after receiving the command to perform the one or more social networking interaction operations.

According to some embodiments, when a target terminal detects that it is no longer present at an event location, which signifies that a social networking event is over, the target terminal can prompt a user to perform one or more social networking interaction operations to share with friends information about the social networking event. According to some embodiments, when a service device detects that a target terminal is no longer present at an event location, which signifies that a social networking event is over, the service device can send a command to perform one or more social networking interaction operations to the target terminal, enabling the target terminal to prompt a user to perform the one or more social networking interaction operations after receiving the command to perform the one or more social networking interaction operations. Therefore, the present disclosure can remind users to perform social networking interaction operations after a social networking event is over, thereby allowing information about the social networking event to be shared with friends.

### BRIEF DESCRIPTION OF THE DRAWINGS

FIG. 1 is a schematic diagram illustrating an example of the flow of an online social networking interaction method according to various embodiments.

FIG. 2 is a schematic diagram illustrating an example of the flow of an online social networking interaction method according to various embodiments.

FIG. 3 is a schematic diagram illustrating an example of the flow of an online social networking interaction method according to various embodiments.

FIG. 4 is a schematic diagram illustrating an example of the flow of an online social networking interaction method according to various embodiments.

FIG. 5 is a schematic diagram illustrating an example of the flow of an online social networking interaction method according to various embodiments.

FIG. 6 is a schematic diagram illustrating an example of the flow of an online social networking interaction method according to various embodiments.

FIG. 7 is a schematic diagram illustrating an example of an arrangement of an online social networking interaction system according to various embodiments.

FIG. 8 is a schematic diagram illustrating an example of an arrangement of a target terminal according to various embodiments.

FIG. 9 is a schematic diagram illustrating an example of an arrangement of an online social networking interaction system according to various embodiments.

FIG. 10 is a schematic diagram illustrating an example of an arrangement of a service device according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

The present disclosure provides an online social networking interaction method and related device and system, which can remind users to perform social networking interaction operations after social networking events, so that information about the social networking events can be shared with friends.

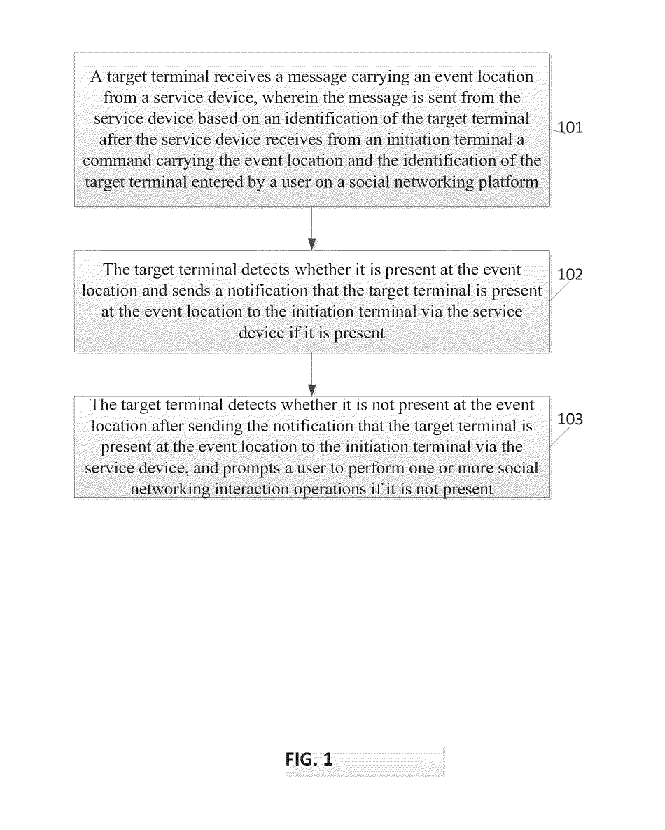

FIG. 1 is a schematic diagram illustrating an example of the flow of an online social networking interaction method according to various embodiments. The method can comprise:

Step 101: a target terminal receives a message carrying an event location from a service device, wherein the message is sent from the service device based on an identification of the target terminal after the service device receives from an initiation terminal a command carrying the event location and the identification of the target terminal entered by a user on a social networking platform.

According to some embodiments, the target terminal and the initiation terminal can each comprise smartphones such as iPhone and those based on the Android operating system, or other mobile Internet devices (“MIDs”) and mobile smart terminals. Terminals can comprise tablets, cellphones, Personal Digital Assistants (“PDAs”), electronic readers, laptops, smart TVs, on-vehicle terminals and other smart devices. A mobile terminal can be a mobile phone, a tablet PC, a media player, etc. Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, or any other mobile Internet device (“MID”) or intelligent communication terminal, all of which are well known to those skilled in the art.

Examples of a social networking platform include, but are not limited to, personal social networking service (“SNS”) spaces, microblogs (such as Tencent microblog and Sina microblog, etc.), and even e-mail boxes.

Examples of an identification of a target terminal can include, but are not limited to, a name of the target terminal and information about a device type associated with the target terminal, etc.

Step 102: the target terminal detects whether it is present at the event location and sends a notification that the target terminal is present at the event location to the initiation terminal via the service device if it is present.

According to some embodiments, the target terminal can have a built-in module that provides location-based service (“LBS”). According to these embodiments, when the target terminal receives a message carrying an event location from a service device, the target terminal can start continuous or periodic location detection to obtain the target terminal's location.

According to some embodiments, if the target terminal detects that it is not present at the event location, it can continue detecting whether it is present at the event location.

According to some embodiments, the target terminal detecting whether it is present at the event location in Step 102 can comprise:

the target terminal detecting whether its location and the event location correspond, and determining that the target terminal is present at the event location if the target terminal's location and the event location correspond, or determining that the target terminal is not present at the event location if the target terminal's location and the event location do not correspond.

As used herein, a target terminal's location and an event location correspond when the target terminal has arrived at the event location. According to some embodiments, a target terminal's location and an event location correspond when the target terminal's location and the event location are identical. According to some other embodiments, a target terminal's location and an event location correspond when the target terminal's location is within the event location, i.e., the event location covers a bigger area that includes the target terminal's location. According to yet some other embodiments, a target terminal's location and an event location correspond when the target terminal's location and the event location overlap, i.e., the area covered by the target terminal's location overlaps with the area covered by the event location.

Step 103: the target terminal detects whether it is not present at the event location after sending the notification that the target terminal is present at the event location to the initiation terminal via the service device, and prompts a user to perform one or more social networking interaction operations if it is not present.

According to some embodiments, the target terminal detecting whether it is not present at the event location after sending the notification that the target terminal is present at the event location to the initiation terminal via the service device in Step 103 can comprise:

the target terminal detecting whether its location and the event location correspond after sending the notification that the target terminal is present at the event location to the initiation terminal via the service device, and determining that the target terminal is not present at the event location if the target terminal's location and the event location do not correspond, or determining that the target terminal is present at the event location if the target terminal's location and the event location correspond.

When a target terminal detects whether its location and an event location correspond, if the target terminal detects the latitude and longitude information of its location and the event location is represented by city or street information, then the target terminal can search a database based on the latitude and longitude information and matches the latitude and longitude information with corresponding city or street information.

According to some embodiments, an event location can be a location selected from an electronic map by an initiation terminal. According to some embodiments, an event location can comprise address information entered by a user on the initiation terminal.

According to some embodiments, a target terminal prompting a user to perform one or more social networking interaction operations can comprise prompting the user to publish videos and pictures, etc., taken during a social networking event to a social networking platform to promptly share them with friends. According to some embodiments, a target terminal prompting a user to perform one or more social networking interaction operations can comprise prompting the user to publish feelings about a social networking event on a social networking platform in the form of one or more weblogs, etc., to promptly share them with friends.

According to some preferred embodiments, a target terminal's performing Steps 101-103 described above does not affect the normal functions of the target terminal.

Optionally, in the online social networking interaction method illustrated by FIG. 1, before the target terminal receives the message carrying the event location from the service device, the method can comprise:

Step 1): the target terminal receives an invitation to a social networking event from the service device, wherein the invitation is sent from the service device based on the identification of the target terminal after the service device receives an invitation to the social networking event carrying the identification of the target terminal from the initiation terminal.

Step 2): the target terminal detects whether it has received a response confirming participation in the social networking event entered by the user, and sends the response confirming participation in the social networking event entered by the user to the initiation terminal via the service device if the target terminal has received the response, or sending a response declining to participate in the social networking event to the initiation terminal via the service device if the target terminal has not received a response confirming participation or has received a response declining to participate in the social networking event entered by the user.

Through the above Step 1) and Step 2), an initiation terminal can clearly identify, out of all the invited target terminals, which target terminals have confirmed participation in a social networking event and which target terminals have declined to participate in the social networking event, thereby allowing the initiation terminal to decide whether to further invite other target terminals to participate in the social networking event.

In an online social networking interaction method illustrated in FIG. 1, when a target terminal detects that it is no longer present at an event location, which signifies that a social networking event is over, the target terminal can prompt a user to perform one or more social networking interaction operations to share with friends information about the social networking event (e.g., videos, pictures, and weblogs, etc.). Therefore, the online social networking interaction method illustrated in FIG. 1 can remind users to perform social networking interaction operations after a social networking event is over, thereby allowing information about the social networking event to be shared with friends.

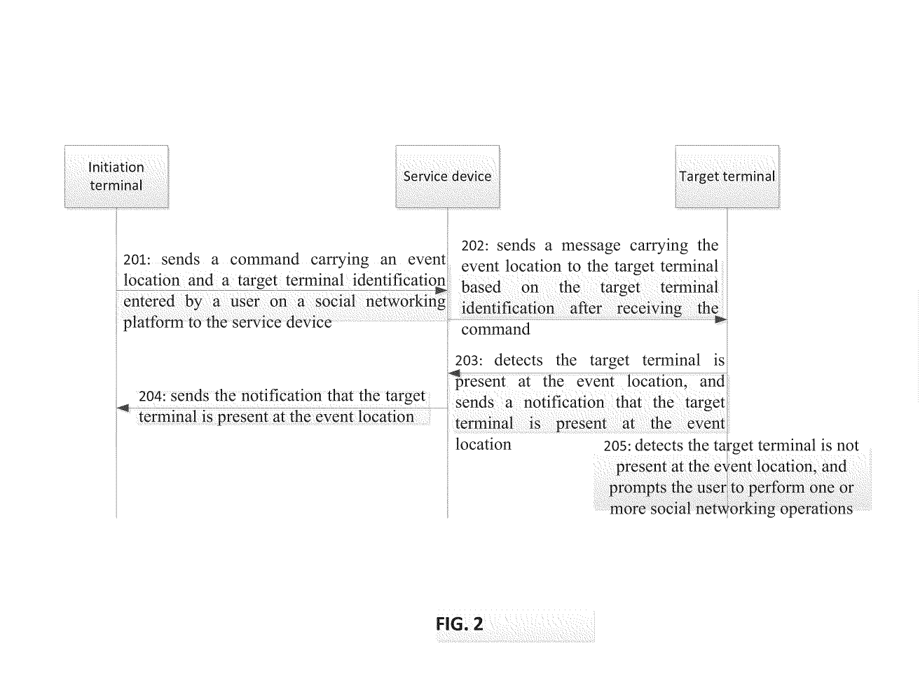

FIG. 2 is a schematic diagram illustrating an example of the flow of an online social networking interaction method according to various embodiments. The method can comprise:

Step 201: an initiation terminal sends a command carrying an event location and a target terminal identification entered by a user on a social networking platform to a service device.

Step 202: the service device sends a message carrying the event location to a target terminal based on the target terminal identification after receiving the command.

Step 203: the target terminal detects whether it is present at the event location after receiving the message, and sends a notification that the target terminal is present at the event location to the service device if the target terminal is present.

According to some embodiments, if the target terminal detects that it is not present at the event location, it can continue to detect whether it is present at the event location.

Step 204: the service device sends the notification that the target terminal is present at the event location to the initiation terminal.

Step 205: the target terminal detects whether it is not present at the event location after sending the notification that the target terminal is present at the event location to the service device, and prompts the user to perform one or more social networking operations if the target terminal is not present.

According to some embodiments, the command entered by the user on the social networking platform can carry a time range for participation in the social networking event (e.g., 09:00-11:00). According to these embodiments, in Step 201, the initiation terminal can send the command carrying the event location, the target terminal identification, and the time range for participation in the social networking event entered by the user on the social networking platform to the service device. Accordingly, in Step 202, the service device, after receiving the command, can send a message carrying the event location and the time range for participation in the social networking event to the target terminal based on the target terminal identification. Accordingly, in Step 203, the target terminal, after receiving the message, can first detect whether a current time is within the time range for participation in the social networking event, then determine whether it is present at the event location if the current time is within the time range, and then send the notification that the target terminal is present at the event location to the service device if the target terminal is present. Of course, if the target terminal detects that the current time is not within the time range for participation in the social networking event, it can nevertheless determine whether it is present at the event location, and send the notification that the target terminal is present at the event location to the service device if the target terminal is present.

In an online social networking interaction method illustrated in FIG. 2, when a target terminal detects that it is no longer present at an event location, which signifies that a social networking event is over, the target terminal can prompt a user to perform one or more social networking interaction operations to share with friends information about the social networking event (e.g., videos, pictures, and weblogs, etc.). Therefore, the online social networking interaction method illustrated in FIG. 2 can remind users to perform social networking interaction operations after a social networking event is over, thereby allowing information about the social networking event to be shared with friends.

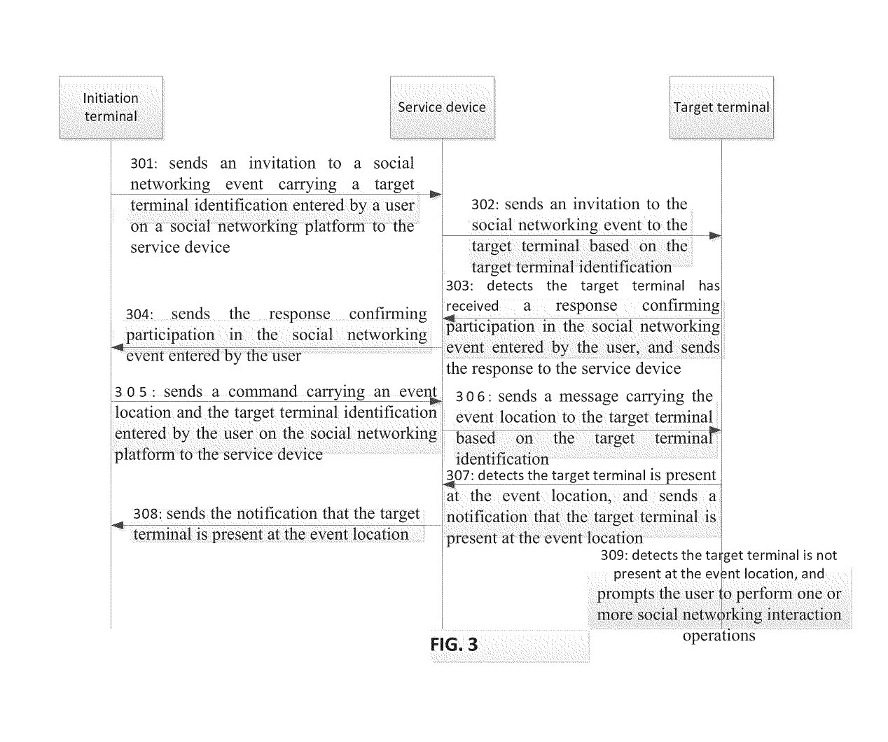

FIG. 3 is a schematic diagram illustrating an example of the flow of an online social networking interaction method according to various embodiments. The method can comprise:

Step 301: an initiation terminal sends an invitation to a social networking event carrying a target terminal identification entered by a user on a social networking platform to a service device.

Step 302: the service device sends an invitation to the social networking event to a target terminal based on the target terminal identification after receiving the invitation carrying the target terminal identification.

Step 303: the target terminal detects whether it has received a response confirming participation in the social networking event entered by the user, and sends the response confirming participation in the social networking event entered by the user to the service device if the target terminal has received the response.

Step 304: the service device sends the response confirming participation in the social networking event entered by the user to the initiation terminal after receiving the response.

Step 305: the initiation terminal sends a command carrying an event location and the target terminal identification entered by the user on the social networking platform to the service device.

Step 306: the service device sends a message carrying the event location to the target terminal based on the target terminal identification after receiving the command.

Step 307: the target terminal detects whether it is present at the event location after receiving the message, and sends a notification that the target terminal is present at the event location to the service device if the target terminal is present.

According to some embodiments, if the target terminal detects that it has not arrived at the event location, it can continue to detect whether it is present at the event location.

Step 308: the service device sends the notification that the target terminal is present at the event location to the initiation terminal.

Step 309: the target terminal detects whether it is not present at the event location after sending the notification that the target terminal is present at the event location, and prompts the user to perform one or more social networking interaction operations if the target terminal is not present at.

In an online social networking interaction method illustrated in FIG. 3, when a target terminal detects that it is not present at an event location, which signifies that a social networking event is over, the target terminal can prompt a user to perform one or more social networking interaction operations to share with friends information about the social networking event (e.g., videos, pictures, and weblogs, etc.). Therefore, the online social networking interaction method illustrated in FIG. 3 can remind users to perform social networking interaction operations after a social networking event is over, thereby allowing information about the social networking event to be shared with friends.

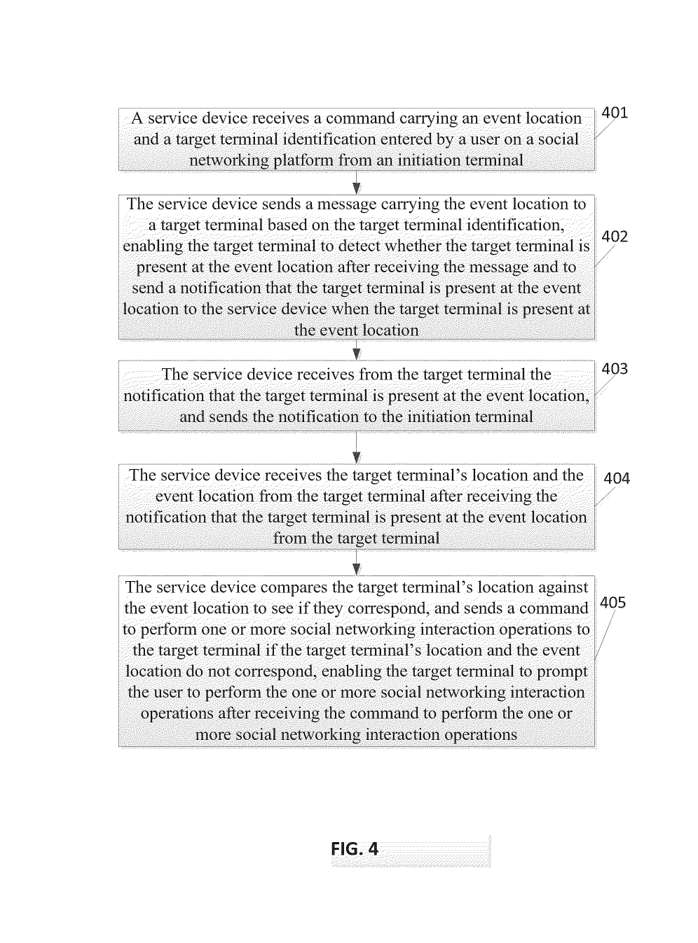

FIG. 4 is a schematic diagram illustrating an example of the flow of an online social networking interaction method according to various embodiments. The method can comprise:

Step 401: a service device receives a command carrying an event location and a target terminal identification entered by a user on a social networking platform from an initiation terminal.

Step 402: the service device sends a message carrying the event location to a target terminal based on the target terminal identification, enabling the target terminal to detect whether the target terminal is present at the event location after receiving the message and to send a notification that the target terminal is present at the event location to the service device when the target terminal is present at the event location.

Step 403: the service device receives from the target terminal the notification that the target terminal is present at the event location, and sends the notification to the initiation terminal.

Step 404: the service device receives the target terminal's location and the event location from the target terminal after receiving the notification that the target terminal is present at the event location from the target terminal.

According to some embodiments, a target terminal can send its location and an event location to a service device every time after the target terminal detects its location via a LBS module.

Step 405: the service device compares the target terminal's location and the event location to see whether they correspond, and sends a command to perform one or more social networking interaction operations to the target terminal if the target terminal's location and the event location do not correspond, enabling the target terminal to prompt the user to perform the one or more social networking interaction operations after receiving the command to perform the one or more social networking interaction operations.

If the service device compares the target terminal's location and the event location and finds they correspond, this means the social networking event is not over yet, and the service device does not need to send the command to perform the one or more social networking interaction operations to the target terminal.

This embodiment enables a server service device to compare a target terminal's location and an event location to see whether they correspond. By taking advantage of the server's capacity to store massive data, the accuracy of determination and the promptness of returning a matching result can be increased especially when the target terminal's location is expressed in latitude and longitude coordinates and the event location is represented by city or street information, the matching of which requires complex computation and determination.

Optionally, in the online social networking interaction method illustrated in FIG. 4, before the service device receives the command carrying the event location and the target terminal identification entered by the user on the social networking platform from the initiation terminal, the method can comprise:

Step 1): the service device receives an invitation to a social networking event carrying the target terminal identification entered by the user on the social networking platform from the initiation terminal.

Step 2): the service device sends an invitation to the social networking event to the target terminal based on the target terminal identification, enabling the target terminal to detect whether it has received a response confirming participation in the social networking event entered by the user, and to send the response confirming participation in the social networking event entered by the user to the service device after receiving the response confirming participation in the social networking event entered by the user.

Step 3): the service device receives the response confirming participation in the social networking event entered by the user from the target terminal and sends the response to the initiation terminal.

Through the above Step 1) through Step 3), an initiation terminal can clearly identify, out of all the invited target terminals, which target terminals have confirmed participation in a social networking event and which target terminals have declined to participate in the social networking event, thereby allowing the initiation terminal to decide whether to further invite other target terminals to participate in the social networking event.

In an online social networking interaction method illustrated in FIG. 4, when a service device detects that a target terminal is no longer present at an event location, which signifies that the social networking event is over, the service device can send a command to perform one or more social networking interaction operations to the target terminal, enabling the target terminal to prompt a user to perform the one or more social networking interaction operations after receiving the command to perform the one or more social networking interaction operations. Therefore, the online social networking interaction method illustrated in FIG. 4 can remind users to perform social networking interaction operations after a social networking event is over, thereby allowing information about the social networking event to be shared with friends.

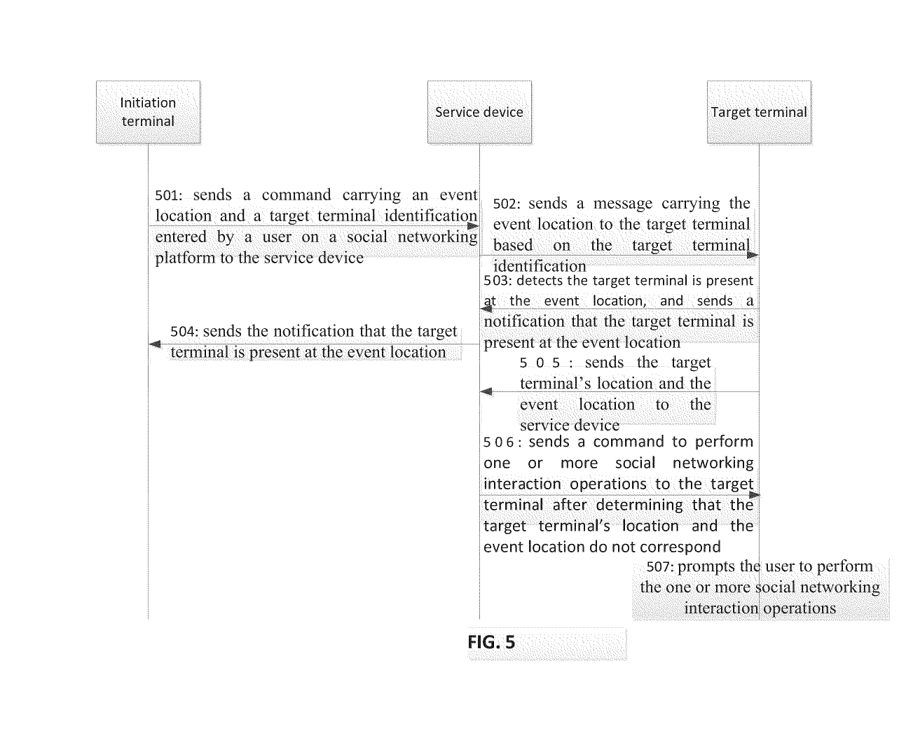

FIG. 5 is a schematic diagram illustrating an example of the flow of an online social networking interaction method according to various embodiments. The method can comprise:

Step 501: an initiation terminal sends a command carrying an event location and a target terminal identification entered by a user on a social networking platform to a service device.

Step 502: the service device sends a message carrying the event location to the target terminal based on the target terminal identification.

Step 503: the target terminal detects whether it is present at the event location after receiving the message, and sends a notification that the target terminal is present at the event location to the service device if the target terminal is present.

According to some embodiments, the target terminal detecting whether it is present at the event location in Step 503 can comprise:

the target terminal detecting whether its location and the event location correspond, and determining that the target terminal is present at the event location if the target terminal's location and the event location correspond, or determining that the target terminal is not present at the event location if the target terminal's location and the event location do not correspond.

According to some embodiments, if a target terminal detects that it is not present at the event location, the target terminal can continue to detect whether it is present at the event location.

Step 504: the service device sends the notification that the target terminal is present at the event location to the initiation terminal.

Step 505: the target terminal sends its location and the event location to the service device after sending the notification that the target terminal is present at the event location to the service device.

Step 506: the service device compares the target terminal's location and the event location after receiving the target terminal's location and the event location to see if they correspond, and sends a command to perform one or more social networking interaction operations to the target terminal if the target terminal's location and the event location do not correspond.

According to some embodiments, if the service device compares the target terminal's location and the event location and finds they correspond, this means the social networking event is not over yet, and the service device does not need to send the command to perform the one or more social networking interaction operations to the target terminal.

Step 507: the target terminal prompts the user to perform the one or more social networking interaction operations after receiving the command to perform the one or more social networking interaction operations.

According to some embodiments, the command entered by the user on the social networking platform can carry a time range for participation in the social networking event (e.g., 09:00-11:00). According to these embodiments, in Step 501, the initiation terminal can send the command carrying the event location, the target terminal identification, and the time range for participation in the social networking event entered by the user on the social networking platform to the service device. Accordingly, in Step 502, the service device, after receiving the command, can send a message carrying the event location and the time range for participation in the social networking event to the target terminal based on the target terminal identification. Accordingly, in Step 503, the target terminal, after receiving the message, can first detect whether a current time is within the time range for participation in the social networking event, then determine whether it is present at the event location if the current time is within the time range, and then send the notification that the target terminal is present at the event location to the service device if the target terminal is present. Of course, if the target terminal detects that the current time is not within the time range for participation in the social networking event, it can nevertheless determine whether it is present at the event location, and send the notification that the target terminal is present at the event location to the service device if the target terminal is present.

In an online social networking interaction method illustrated in FIG. 5, when a service device detects that a target terminal is not present at an event location, which signifies that the social networking event is over, the service device can send a command to perform one or more social networking interaction operations to the target terminal, enabling the target terminal to prompt a user to perform the one or more social networking interaction operations after receiving the command to perform the one or more social networking interaction operations. Therefore, the online social networking interaction method illustrated in FIG. 5 can remind users to perform social networking interaction operations after a social networking event is over, thereby allowing information about the social networking event to be shared with friends.

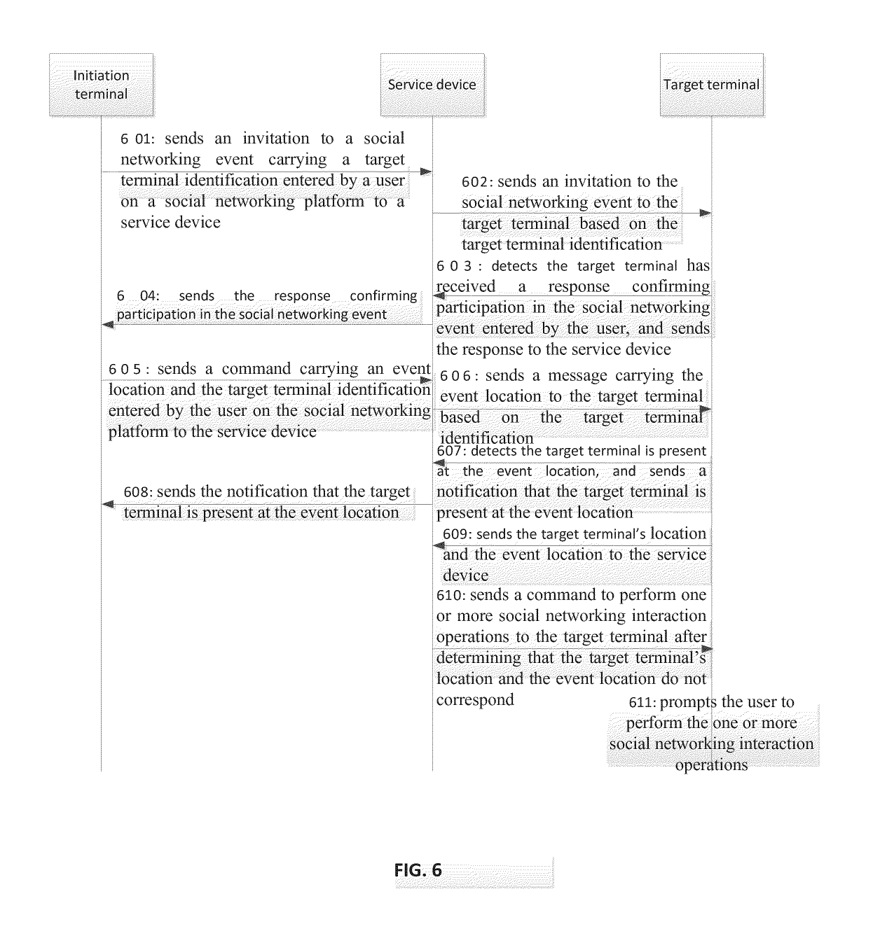

FIG. 6 is a schematic diagram illustrating an example of the flow of an online social networking interaction method according to various embodiments. The method can comprise:

Step 601: an initiation terminal sends an invitation to a social networking event carrying a target terminal identification entered by a user on a social networking platform to a service device.

Step 602: the service device sends an invitation to the social networking event to the target terminal based on the target terminal identification after receiving the invitation to the social networking event carrying the target terminal identification.

Step 603: the target terminal detects whether it has received a response confirming participation in the social networking event entered by the user, and sends the response confirming participation in the social networking event entered by the user to the service device if it has received the response.

Step 604: the service device receives the response confirming participation in the social networking event entered by the user and sends it to the initiation terminal.

Step 605: the initiation terminal sends a command carrying an event location and the target terminal identification entered by the user on the social networking platform to the service device.

Step 606: the service device sends a message carrying the event location to the target terminal based on the target terminal identification after receiving the command.

Step 607: the target terminal detects whether it is present at the event location after receiving the message, and sends a notification that the target terminal is present at the event location to the service device if the target terminal is present.

Step 608: the service device sends the notification that the target terminal is present at the event location to the initiation terminal.

Step 609: the target terminal sends its location and the event location to the service device after sending the notification that the target terminal is present at the event location to the service device.

Step 610: the service device compares the target terminal's location and the event location after receiving the target device's location and the event location to see whether they correspond, and sends a command to perform one or more social networking interaction operations to the target terminal if the target terminal's location and the event location do not correspond.

Step 611: the target terminal prompts the user to perform the one or more social networking interaction operations after receiving the command to perform the one or more social networking interaction operations.

In an online social networking interaction method illustrated in FIG. 6, when a service device detects that a target terminal is no longer present at an event location, which signifies that a social networking event is over, the service device can send a command to perform one or more social networking interaction operations to the target terminal, enabling the target terminal to prompt a user to perform the one or more social networking interaction operations after receiving the command to perform the one or more social networking interaction operations. Therefore, the online social networking interaction method illustrated in FIG. 6 can remind users to perform social networking interaction operations after a social networking event is over, thereby allowing information about the social networking event to be shared with friends.

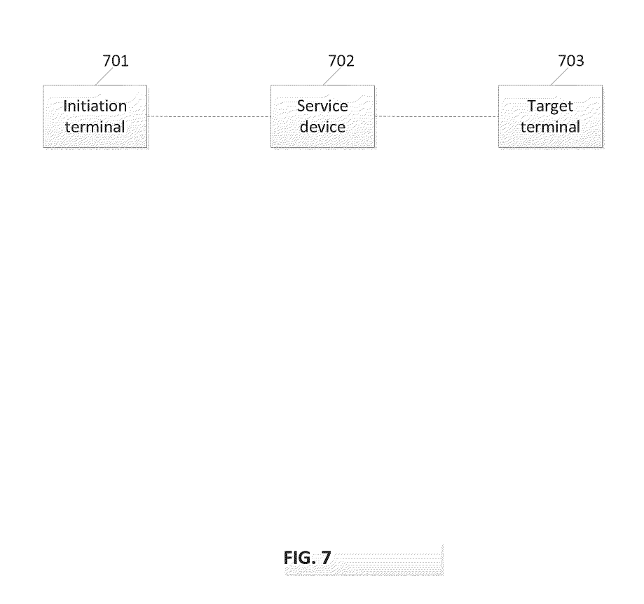

FIG. 7 is a schematic diagram illustrating an example of an arrangement of an online social networking interaction system according to various embodiments. As illustrated in FIG. 7, the system can comprise: an initiation terminal 701, a service device 702, and a target terminal 703. Dotted lines in FIG. 7 indicate wireless connection.

The initiation terminal 701 sends a command carrying an event location and a target terminal identification entered by a user on a social networking platform to the service device 702;

The service terminal 702 sends a message carrying the event location to the target terminal 703 based on the target terminal identification after receiving the command;

The target terminal 703 detects whether it is present at the event location after receiving the message, and sends a notification that the target terminal is present at the event location to the service device 702 if the target terminal is present.

The service device 702 also sends the notification that the target terminal is present at the event location to the initiation terminal 101.

The target terminal 703 also detects whether it is not present at the event location after sending the notification that the target terminal is present at the event location to the service device 702, and prompts a user to perform one or more social networking interaction operations if the target terminal is not present.

According to some embodiments, the initiation terminal 701 can send an invitation to a social networking event carrying the target terminal identification to the service device 702 before sending the command carrying the event location and the target terminal identification to the service device 702. Accordingly, the service device 702 can send an invitation to the social networking event to the target terminal 703 based on the target terminal identification after receiving the invitation to the social networking event carrying the target terminal identification. Accordingly, the target terminal 703 can detect whether it has received a response confirming participation in the social networking event entered by the user, and send the response confirming participation in the social networking event to the service device 702 if it has received the response. The service device 702 can also send the response confirming participation in the social networking event to the initiation terminal 701 after receiving the response. According to these embodiments, the initiation terminal 701 can clearly identify, out of all the invited target terminals, which target terminals have confirmed participation in the social networking event and which target terminals have declined to participate in the social networking event, thereby allowing the initiation terminal to decide whether to further invite other target terminals to participate in the social networking event.

According to some embodiments, after receiving the message, the target terminal 703 detecting whether it is present at the event location can comprise:

The target terminal 703 detecting whether its location and the event location correspond, and determining that the target terminal is present at the event location if the target terminal's location and the event location correspond, or determining that the target terminal is not present at the event location if the target terminal's location and the event location do not correspond.

According to some embodiments, after sending the notification that the target terminal is present at the event location to the service device 702, the target terminal 703 detecting whether it is not present at the event location can comprise:

The target terminal 703 detecting whether its location and the event location correspond after sending the notification that the target terminal is present at the event location to the service device 702, and determining that the target terminal is not present at the event location if the target terminal's location and the event location do not correspond, or determining that the target terminal is present at the event location if the target terminal's location and the event location correspond.

In an online social networking interaction system illustrated in FIG. 7, the command entered by the user on the social networking platform can carry a time range for participation in the social networking event (e.g., 09:00-11:00). According to these embodiments, the initiation terminal 701 can send a command carrying the event location, the target terminal identification, and the time range for participation in the social networking event entered by the user on the social networking platform to the service device 702. Accordingly, the service device 702, after receiving the command, can send a message carrying the event location and the time range for participation in the social networking event to the target terminal 703 based on the target terminal identification. Accordingly, the target terminal 703, after receiving the message, can first detect whether a current time is within the time range for participation in the social networking event, then determine whether it is present at the event location if the current time is within the time range, and then send the notification that the target terminal is present at the event location to the service device 702 if the target terminal is present. Of course, if the target terminal 703 detects that the current time is not within the time range for participation in the social networking event, it can nevertheless determine whether it is present at the event location, and send the notification that the target terminal is present at the event location to the service device 702 if the target terminal is present.

In an online social networking interaction system illustrated in FIG. 7, when a target terminal 703 detects that it is no longer present at an event location, which signifies that a social networking event is over, the target terminal 703 can prompt a user to perform one or more social networking interaction operations to share with friends information about the social networking event (e.g., videos, pictures, and weblogs, etc.). Therefore, the online social networking interaction system illustrated in FIG. 7 can remind users to perform social networking interaction operations after a social networking event is over, thereby allowing information about the social networking event to be shared with friends.

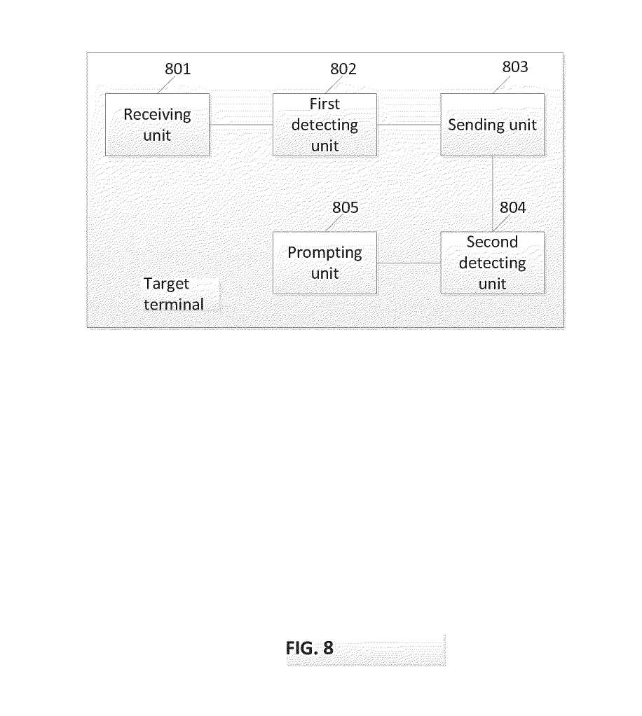

FIG. 8 is a schematic diagram illustrating an example of an arrangement of a target terminal according to various embodiments. The target terminal can comprise:

A receiving unit 801 that receives a message carrying an event location from a service device, wherein the message is sent from the service device based on a target terminal identification after the service device receives a command carrying the event location and the target terminal identification entered by a user on a social networking from an initiation terminal.

A first detecting unit 802 that detects whether the target terminal is present at the event location.

A sending unit 803 that sends a notification that the target terminal is present at the event location to the initiation terminal via the service device if the first detecting unit 802 detects that the target terminal is present at the event location.

A second detecting unit 804 that detects whether the target terminal is not present at the event location after the sending unit 803 has sent the notification that the target terminal is present at the event location to the initiation terminal via the service device.

A prompting unit 805 that prompts a user to perform one or more social networking interaction operations if the second detecting unit 804 detects that the target terminal is not present at the event location.

According to some embodiments, in the target terminal illustrated in FIG. 8, the receiving unit 801 can receive an invitation to a social networking event from the service device before receiving the message carrying the event location from the service device, wherein the invitation to the social networking event is sent to the target terminal based on the target terminal identification after the service device receives an invitation to the social networking event carrying the target terminal identification from the initiation terminal. Accordingly, the first detecting unit 802 can detect whether it has received a response confirming participation in the social networking event entered by a user. Accordingly, the sending unit 803 can send the response confirming participation in the social networking event entered by the user to the initiation terminal via the service device after the first detecting unit 802 detects that it has received the response confirming participation in the social networking event entered by the user. According to these embodiments, the initiation terminal can clearly identify, out of all the invited target terminals, which target terminals have confirmed participation in the social networking event and which target terminals have declined to participate in the social networking event, thereby allowing the initiation terminal to decide whether to further invite other target terminals to participate in the social networking event.

According to some embodiments, the first detecting unit 802 can detect whether its location and the event location correspond, and determine that the target terminal is present at the event location if its location and the event location correspond, or determine that the target terminal is not present at the event location if its location and the event location do not correspond.

According to some embodiments, the second detecting unit 804 can detect whether its location and the event location correspond after the sending unit 803 sends the notification that the target terminal is present at the event location to the initiation terminal via the service device, and determine that the target terminal is not present at the event location if its location and the event location do not correspond, or determine that the target terminal is present at the event location if its location and the event location correspond.

In the target terminal illustrated in FIG. 8, the receiving unit 801 can also receive a message carrying the event location and a time range for participation in the social networking event from the service device. Accordingly, the first detecting unit 802 can first detect whether a current time is within the time range for participation in the social networking event, then determine whether it is present at the event location if the current time is within the time range. The sending unit 803 can then send the notification that the target terminal is present at the event location to the initiation terminal via the service device if the first detecting unit is present.

In the target terminal illustrated in FIG. 8, when the target terminal detects that it is no longer present at an event location, which signifies that a social networking event is over, the target terminal can prompt a user to perform one or more social networking interaction operations to share with friends information about the social networking event (e.g., videos, pictures, and weblogs, etc.). Therefore, the target terminal illustrated in FIG. 8 can remind users to perform social networking interaction operations after a social networking event is over, thereby allowing information about the social networking event to be shared with friends.

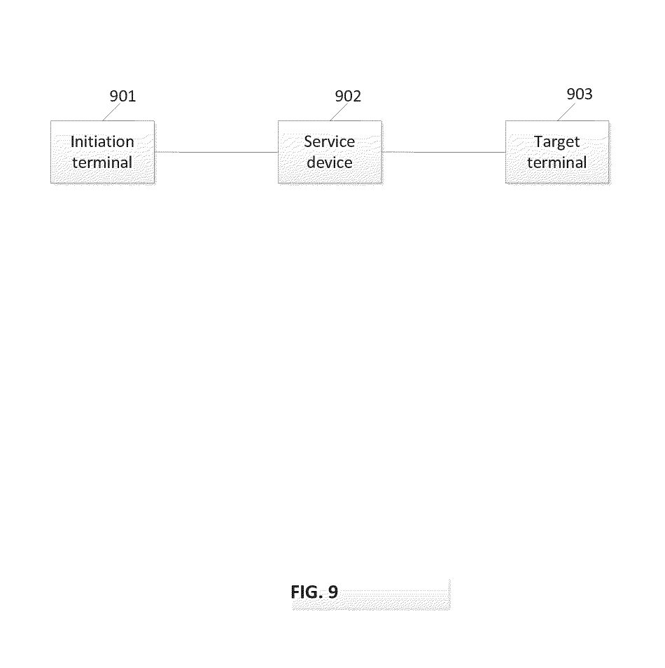

FIG. 9 is a schematic diagram illustrating an example of an arrangement of an online social networking interaction system according to various embodiments. As illustrated in FIG. 9, the system can comprise: an initiation terminal 901, a service device 902, and a target terminal 903, wherein

The initiation terminal 901 sends a command carrying an event location and a target terminal identification entered by a user on a social networking platform to the service device 902;

The service device 902 sends a message carrying the event location to the target terminal 903 based on the target terminal identification after receiving the command;

The target terminal 903 detects whether it is present at the event location after receiving the message, and sends a notification that the target terminal is present at the event location to the service device 902 if the target terminal is present.

The service device 902 also sends the notification that the target terminal is present at the event location to the initiation terminal 901.

The target terminal 903 also sends its location and the event location to the service device 902 after sending the notification that the target terminal is present at the event location to the service device 902.

The service device 902 also compares the target terminal's location and the event location to see whether they correspond after receiving the target terminal's location and the event location, and sends a command to perform one or more social networking interaction operations to the target terminal 903 if the target terminal's location and the event location do not correspond.

The target terminal 903 also prompts a user to perform the one or more social networking interaction operations after receiving the command to perform the one or more social networking interaction operations.

According to some embodiments, the initiation terminal 901 can also send an invitation to a social networking event carrying the target terminal identification entered by the user on the social networking platform to the service device 902 before sending the command carrying the event location and the target terminal identification entered by the user on the social networking platform to the service device 902. Accordingly, the service device 902 can also send an invitation to the social networking event to the target terminal 903 based on the target terminal identification after receiving the invitation to the social networking event carrying the target terminal identification. Accordingly, the target terminal 903 can also detect whether it has received a response confirming participation in the social networking event entered by the user, and send the response confirming participation in the social networking event entered by the user to the service device 902 if it has received the response. The service device 902 can send the response confirming participation in the social networking event entered by the user to the initiation terminal 901 after receiving the response. According to these embodiments, the initiation terminal 901 can clearly identify, out of all the invited target terminals, which target terminals have confirmed participation in the social networking event and which target terminals have declined to participate in the social networking event, thereby allowing the initiation terminal to decide whether to further invite other target terminals to participate in the social networking event.

According to some embodiments, after receiving the message, the target terminal 903 detecting whether it is present at the event location can comprise:

The target terminal 903 detecting whether its location and the event location correspond, and determining that the target terminal is present at the event location if the target terminal's location and the event location correspond, or determining that the target terminal is not present at the event location if the target terminal's location and the event location do not correspond.

In an online social networking interaction system illustrated in FIG. 9, the command entered by the user on the social networking platform can carry a time range for participation in the social networking event (e.g., 09:00-11:00). According to these embodiments, the initiation terminal 901 can send a command carrying the event location, the target terminal identification, and the time range for participation in the social networking event entered by the user on the social networking platform to the service device 902. Accordingly, the service device 902, after receiving the command, can send a message carrying the event location and the time range for participation in the social networking event to the target terminal 903 based on the target terminal identification. Accordingly, the target terminal, after receiving the message, can first detect whether a current time is within the time range for participation in the social networking event, then determine whether it is present at the event location if the current time is within the time range, and then send the notification that the target terminal is present at the event location to the service device 902 if the target terminal is present. Of course, if the target terminal 903 detects that the current time is not within the time range for participation in the social networking event, it can nevertheless determine whether it is present at the event location, and send the notification that the target terminal is present at the event location to the service device 902 if the target terminal is present.

In an online social networking interaction system illustrated in FIG. 9, when a service device 902 detects that a target terminal is no longer present at an event location, which signifies that a social networking event is over, the service device 902 can send a command to perform one or more social networking interaction operations to the target terminal 903, enabling the target terminal 903 to prompt a user to perform the one or more social networking interaction operations after receiving the command to perform the one or more social networking interaction operations. Therefore, the online social networking interaction system illustrated in FIG. 9 can remind users to perform social networking interaction operations after a social networking event is over, thereby allowing information about the social networking event to be shared with friends.

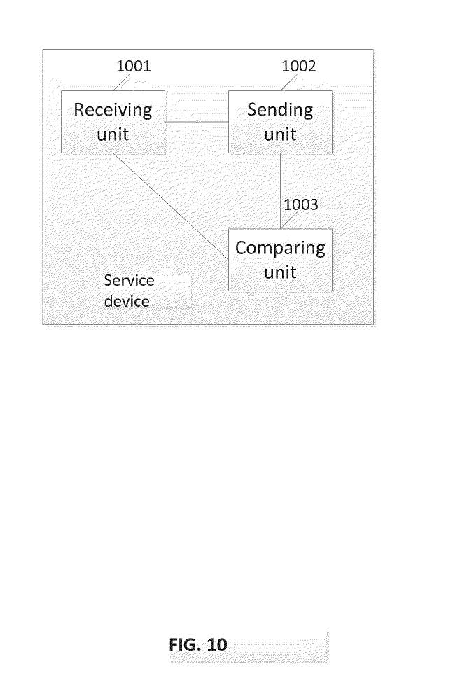

FIG. 10 is a schematic diagram illustrating an example of an arrangement of a service device according to various embodiments. The service device can comprise:

A receiving unit 1001 that receives a command carrying an event location and a target terminal identification entered by a user on a social networking platform from an initiation terminal; and

A sending unit 1002 that sends a message carrying the event location to the target terminal based on the target terminal identification, enabling the target terminal to detect whether the target terminal is present at the event location after receiving the message, and to send a notification that the target terminal is present at the event location to the service device when the target terminal is present at the event location; wherein

The receiving unit 1001 also receives the notification that the target terminal is present at the event location from the target terminal;

The sending unit 1002 sends the notification that the target terminal is present at the event location to the initiation terminal; and

The receiving unit 1001 receives the target terminal's location and the event location from the target terminal after receiving the notification that the target terminal is present at the event location from the target terminal;

A comparing unit 1003 that compares the target terminal's location and the event location to see whether they correspond;

The sending unit 1002 sends a command to perform one or more social networking interaction operations to the target terminal when the comparing unit 1003 determines that the target terminal's location and the event location do not correspond, enabling the target terminal to prompt the user to perform the one or more social networking interaction operations after receiving the command to perform the one or more social networking interaction operations.

According to some embodiments, in a service device illustrated in FIG. 10, the receiving unit 1001 can also receive an invitation to a social networking event carrying the target terminal identification entered by the user on the social networking platform from the initiation terminal before receiving the command carrying the event location and the target terminal identification entered by the user on the social networking platform from the initiation terminal. Accordingly, the sending unit 1002 can also send an invitation to the social networking event to the target terminal based on the target terminal identification, enabling the target terminal to detect whether the target terminal has received a response confirming participation in the social networking event entered by a user, and to send the response confirming participation in the social networking event entered by the user to the service device after receiving the response confirming participation in the social networking event. Accordingly, the receiving unit 1001 can also receive the response confirming participation in the social networking event from the target terminal. Accordingly, the sending unit 1002 can also send the response confirming participation in the social networking event entered by the user to the initiation terminal. According to these embodiments, the initiation terminal can clearly identify, out of all the invited target terminals, which target terminals have confirmed participation in the social networking event and which target terminals have declined to participate in the social networking event, thereby allowing the initiation terminal to decide whether to further invite other target terminals to participate in the social networking event.

In a service device illustrated in FIG. 10, the receiving unit 1001 can also receive a command carrying the event location, the target terminal identification, and a time range for participation in the social networking event (e.g., 09:00-11:00) entered by the user on the social networking platform from the initiation terminal. Accordingly, the sending unit 1002 can send a message carrying the event location and the time range for participation in the social networking event to the target terminal based on the target terminal identification, enabling the target terminal to first detect whether a current time is within the time range for participation in the social networking event, then determine whether it is present at the event location if the current time is within the time range, and then send the notification that the target terminal is present at the event location to the service device if the target terminal is present. Of course, if the target terminal detects that the current time is not within the time range for participation in the social networking event, it can nevertheless determine whether it is present at the event location, and send the notification that the target terminal is present at the event location to the service device if the target terminal is present.

In a service device illustrated in FIG. 10, when the service device detects that a target terminal is no longer present at an event location, which signifies that a social networking event is over, the service device can send a command to perform one or more social networking interaction operations to the target terminal, enabling the target terminal to prompt a user to perform the one or more social networking interaction operations after receiving the command to perform the one or more social networking interaction operations. Therefore, the service device illustrated in FIG. 10 can remind users to perform social networking interaction operations after a social networking event is over, thereby allowing information about the social networking event to be shared with friends.

Those skilled in the art will readily appreciate that a social networking event may not be limited by a particular event location but may be related to any criterion identifiable by a terminal or a service device, e.g., time, or whether a target terminal has started or completed a task online. Therefore, although embodiments disclosed herein may be described and illustrated herein in terms of detecting whether a target terminal is present at an event location, and the corresponding invitation to a social networking event, command, and message disclosed herein may be described to involve the event location, it should be understood that the embodiments are not so limited, but can be additionally applicable to any criterion relevant to a social networking event and identifiable by the target terminal or the service device. By way of example only, if a social networking event is scheduled to happen within a time range, then a user may be prompted to perform one or more social networking interaction operations by a target terminal when the target terminal detects that the scheduled time range has lapsed. Accordingly, the corresponding invitation to the social networking event, and the corresponding message and command, can carry the time range instead of (if the social networking event is not to be limited by a particular event location), or in addition to, an event location. Similarly, a social networking event can be related to a task online, e.g., participation in an online game or leaving comments in an online forum. Accordingly, the target terminal or the service device can detect whether a target terminal has started the task online (e.g., whether it has started to play the online game or has logged in the online forum) and whether the target terminal has completed the task online (e.g., whether it has finished the online game or has logged out of the online forum). When it has been determined that the target terminal has completed the task online, the target terminal can prompt a user to perform one or more social networking interaction operations related to the social networking event. According to these embodiments, the corresponding invitation to the social networking event, and the corresponding message and command, can carry the criteria to determine if the task online has been started or completed instead of (if the social networking event is not to be limited by a particular event location), or in addition to, an event location. Examples of such criteria are well known to those skilled in the art.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An online social networking interaction method comprising:
receiving a message carrying an event location from a service device,
detecting whether a target terminal is present at the event location,
sending a notification that the target terminal is present at the event location to the service device if the target terminal is present at the event location,
detecting whether the target terminal is not present at the event location, and
prompting a user to perform one or more social networking operations if the target terminal is not present at the event location.

2. The method of claim 1, comprising:
receiving an invitation to a social networking event from the service device,
detecting whether the target terminal has received a response confirming participation in the social networking event entered by the user, and
sending the response confirming participation in the social networking event entered by the user to the service device if the target terminal has received the response.

3. The method of claim 1, wherein detecting whether the target terminal is present at the event location comprises:
detecting whether the target terminal's location and the event location correspond, wherein
the target terminal is determined to be present at the event location if the target terminal's location and the event location correspond, and the target terminal is determined to not be present at the event location if the target terminal's location and the event location do not correspond.

4. The method of claim 1, wherein detecting whether the target terminal is not present at the event location comprises:
detecting whether the target terminal's location and the event location correspond, wherein
the target terminal is determined to not be present at the event location if the target terminal's location and the event location do not correspond, and the target terminal is determined to be present at the event location if the target terminal's location and the event location correspond.

5. The method of claim 1, wherein:
the message carrying the event location is sent from the service device based on a target terminal identification after the service device receives a command carrying the event location and the target terminal identification entered by the user on a social networking platform from an initiation terminal, and
sending the notification that the target terminal is present at the event location to the service device comprises sending the notification that the target terminal is present at the event location to the initiation terminal via the service device.

6. The method of claim 2, wherein
the invitation to the social networking event is sent from the service device based on a target terminal identification after the service device receives an invitation to the social networking event carrying the target terminal identification from an initiation terminal, and
sending the response confirming participation in the social networking event entered by the user to the service device comprises sending the response confirming participation in the social networking event entered by the user to the initiation terminal via the service device.

7. An online social networking interaction method comprising:
receiving a message carrying an event location from a service device,
detecting whether a target terminal is present at the event location,
sending a notification that the target terminal is present at the event location to the service device if the target terminal is present at the event location,
sending the target terminal's location and the event location to the service device, enabling the service device to compare the target terminal's location and the event location, and to send a command to perform one or more social networking interaction operations to the target terminal if the target terminal's location and the event location do not correspond,
receiving the command to perform the one or more social networking interaction operations, and
prompting the user to perform the one or more social networking operations.

8. The method of claim 7, comprising:
receiving an invitation to a social networking event from the service device,
detecting whether the target terminal has received a response confirming participation in the social networking event entered by the user, and
sending the response confirming participation in the social networking event entered by the user to the service device if the target terminal has received the response.

9. The method of claim 7, wherein detecting whether the target terminal is present at the event location comprises:
detecting whether the target terminal's location and the event location correspond, wherein
the target terminal is determined to be present at the event location if the target terminal's location and the event location correspond, and the target terminal is determined to not be present at the event location if the target terminal's location and the event location do not correspond.

10. An online social networking interaction method comprising:
receiving a command carrying an event location and a target terminal identification entered by a user on a social networking platform from an initiation terminal,
sending a message carrying the event location to a target terminal based on the target terminal identification, enabling the target terminal to detect whether the target terminal is present at the event location, and to send a notification that the target terminal is present at the event location when the target terminal is present at the event location,
receiving the notification that the target terminal is present at the event location from the target terminal, and
sending the notification that the target terminal is present at the event location to the initiation terminal.

11. The method of claim 10, comprising:
receiving an invitation to a social networking event carrying the target terminal identification entered by the user on the social networking platform from the initiation terminal,
sending an invitation to the social networking event to the target terminal based on the target terminal identification, enabling the target terminal to detect whether the target terminal has received a response confirming participation in the social networking event entered by the user, and to send the response confirming participation in the social networking event entered by the user after the target terminal has received the response confirming participation in the social networking event entered by the user,
receiving the response confirming participation in the social networking event entered by the user from the target terminal, and
sending the response confirming participation in the social networking event entered by the user to the initiation terminal.

12. The method of claim 10, comprising:
receiving the target terminal's location and the event location from the target terminal,
comparing the target terminal's location and the event location to see if they correspond, and
sending a command to perform one or more social networking interaction operations to the target terminal if the target terminal's location and the event location do not correspond, enabling the target terminal to prompt the user to perform the one or more social networking interaction operations.

13. A target terminal comprising:
a receiving unit that receives a message carrying an event location from a service device, wherein the message is sent from the service device based on a target terminal identification after the service device receives a command carrying the event location and the target terminal identification entered by a user on a social networking platform from an initiation terminal,
a first detecting unit that detects whether the target terminal is present at the event location,
a sending unit that sends a notification that the target terminal is present at the event location to the initiation terminal via the service device when the first detecting unit detects that the target terminal is present at the event location,
a second detecting unit that detects whether the target terminal is not present at the event location after the sending unit sends the notification that the target terminal is present at the event location to the initiation terminal via the service device, and
a prompting unit that prompts the user to perform one or more social networking interaction operations when the second detecting unit detects that the target terminal is not present at the event location.

14. The target terminal of claim 13, wherein
the receiving unit receives an invitation to a social networking event from the service device before receiving the message carrying the event location from the service device, wherein the invitation to the social networking event is sent from the service device based on the target terminal identification after the service device receives an invitation to the social networking event carrying the target terminal identification from the initiation terminal,
the first detecting unit detects whether the target terminal has received a response confirming participation in the social networking event entered by the user, and
the sending unit sends the response confirming participation in the social networking event entered by the user to the initiation terminal via the service device after the first detecting unit detects that the target terminal has received the response confirming participation in the social networking event entered by the user.

15. The target terminal of claim 13, wherein
the first detecting unit detects whether the first detecting unit's location and the event location correspond, and determines that the target terminal is present at the event location if the first detecting unit's location and the event location correspond, or determines that the target terminal is not present at the event location if the first detecting unit's location and the event location do not correspond.

16. The target terminal of claim 13, wherein
the second detecting unit detects whether the second detecting unit's location and the event location correspond after the sending unit sends the notification that the target terminal is present at the event location to the initiation terminal via the service device, and determines that the target terminal is not present at the event location if the second detecting unit's location and the event location do not correspond, or determines that the target terminal is present at the event location if the second detecting unit's location and the event location correspond.
